(19) United States
(12) Patent Application Publication
(10) Pub. No.: US 2017/0288516 A1
(43) Pub. Date: Oct. 5, 2017

(54) STATIONARY COIL SUPPORT FOR A BRUSHLESS ALTERNATOR AND A BRUSHLESS ALTERNATOR COMPRISING THE SAME

(71) Applicant: Dixie Electric Ltd., Concord (CA)

(72) Inventor: Bogdan Ionele, Thornhill (CA)

(21) Appl. No.: 15/477,743

(22) Filed: Apr. 3, 2017

Related U.S. Application Data
(60) Provisional application No. 62/317,818, filed on Apr. 4, 2016.

(51) Int. Cl. H02K 19/24; H02K 3/46

(52) U.S. Cl. CPC H02K 19/24; H02K 3/46; H02K 19/16

(57) ABSTRACT

An alternator with a longer stationary coil support or bobbin and rotor axial and components thereof are provided.

### CROSS-REFERENCE TO RELATED APPLICATIONS

This application claims priority to U.S. Application No. 62/317,818, filed Apr. 4, 2016, which is incorporated herein by reference in its entirety and for all purposes.

### FIELD OF THE INVENTION

This invention relates to a stationary coil support for a brushless alternator and a brushless alternator comprising the same. In particular, this invention relates to a front direct mounted stationary coil assembly.

### BACKGROUND OF THE INVENTION

Alternators convert mechanical rotational motion into electrical energy. In vehicles, such as cars and trucks, alternators are used to convert a portion of the power generated by the vehicles internal combustion engine into electrical energy to charge the vehicle's battery and power the electrical systems on the vehicle. Depending on the application, the alternator has to reliably generate a significant amount of electrical power.

An alternator, in general, has two primary components, namely the rotor and stator. The rotor is a rotating magnet and is powered by source of rotational motion, for example, a drive belt integrated with the vehicle's engine. The source of magnetic field is rotor excitation windings energized with electric current. The brushless claw type rotor has a stationary type excitation in that the excitation winding does not rotate with the rotor. The excitation winding coil is wound on the fixed stationary coil support that is rigidly attached to the alternator mounting frames.

The rotor is a series of magnetically permeable “North” and “South” poles that go inside the stator. In operation, the rotating magnetic field of the rotor within the stator generates an alternating voltage within the coils of the stator.

The rotor comprises a solid steel core onto which the magnetically permeable claw type poles are placed. Brushless claw type rotors also include a stationary excitation coil wound around a stationary coil support/steel bobbin which is usually mounted in the rear side of the alternator. The flow of electrical current in the excitation windings generates magnetism into the magnetic circuit of the alternator, effectively charging the stator teeth with magnetism. The higher the value of the magnetic flux density (Tesla) into the stator rotor claws and stator teeth the better the coil support design for the given amount of Ampere Turns of the excitation.

The diameter and length of the rotor and also stationary coil support is limited by the volume available for the alternator. Therefore the limited size stationary coil support/bobbin needs to provide a high level of magnetic flux (Wb) to the rest of the magnetic circuit of the alternator.

It is therefore desirable to have a bobbin which more efficiently carries the magnetic flux that ultimately has to reach the stator teeth.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a stationary coil support for a brushless alternator and a brushless alternator comprising the same. In accordance with an aspect of the invention, there is provided a claw type, brushless alternator comprising a drive end frame having a stationary coil assembly mounted thereto; the stationary coil assembly comprising a hollow bobbin and stationary coil wound thereon; a stator circumscribing the stationary coil assembly such that a gap is provided between the stationary coil assembly and the stator; a rotor assembly having a rotor shaft with pair of opposing claw type poles mounted thereon; wherein each claw type pole has a plurality of fingers; wherein upon installation into the alternator, the rotor shaft is mounted through the hollow bobbin and the plurality of fingers are sandwiched between the stationary coil assembly and the stator.

In accordance with another aspect of the invention, there is provided a bobbin assembly for use in a claw type, brushless alternator, the brushless alternator having a drive end frame and drive end bearing, the bobbin assembly comprising a hollow bobbin with lips at each end of the hollow bobbin and defining a coil winding surface; and a stationary coil wound on the hollow bobbin; wherein one lip of the bobbin is configured for direct mounting to the drive end frame of the alternator and comprises a surface to support the drive end bearing.

In accordance with another aspect of the invention, there is provided a bobbin for use in a claw type, brushless alternator, the brushless alternator having a drive end frame and drive end bearing, the bobbin comprising a hollow cylinder with lips at each end of the hollow cylinder and defining a coil winding surface; wherein one lip of the bobbin is configured for direct mounting to the drive end frame of the alternator and comprises a surface to support the drive end bearing.

### BRIEF DESCRIPTION OF THE DRAWINGS

Embodiments of the invention will now be described, by way of example only, by reference to the attached Figures, wherein:

FIG. 1 illustrates a cross-sectional view of a prior art design for a typical claw type brushless alternator with all the main components properly aligned as for working condition detailing rotor shaft (1), drive end ball bearing (2), fan (3), nut (4), pulley (5), drive end frame (6), bearing cap (7), drive end screws (8), bobbin/stationary coil assembly (9), rear end screws (10), and rear end frame (11).

FIG. 2 illustrates an exploded cross-sectional view of the prior art design for a typical claw type brushless alternator shown in FIG. 1.

FIG. 3 illustrates a cross-sectional side view of one embodiment of the alternator with drive-end direct mounted stationary coil assembly detailing rotor shaft (1), drive end ball bearing (2), fan (3), nut (4), pulley (5), drive end frame (6), drive end screws (8), bobbin/stationary coil assembly (9), rear end screws (10), and rear end frame (11).

FIG. 4 illustrates an exploded cross-sectional view of the alternator shown in FIG. 3.

FIG. 5 illustrates cross-sectional and side views of a prior art design for a stationary coil assembly.

FIG. 6 illustrates cross-sectional and side views of a stationary coil assembly according to one embodiment of the invention.

FIG. 7 illustrates cross-sectional and side views of a stationary coil assembly according to one embodiment of the invention.

FIG. 8 illustrates an alternative design wherein the front bearing in this case is wider. The front bearing is longitudinally clamped between the drive end housing and bobbin. In this embodiment, the bobbin is axially located by the outer race of the bearing.

### DETAILED DESCRIPTION OF THE INVENTION

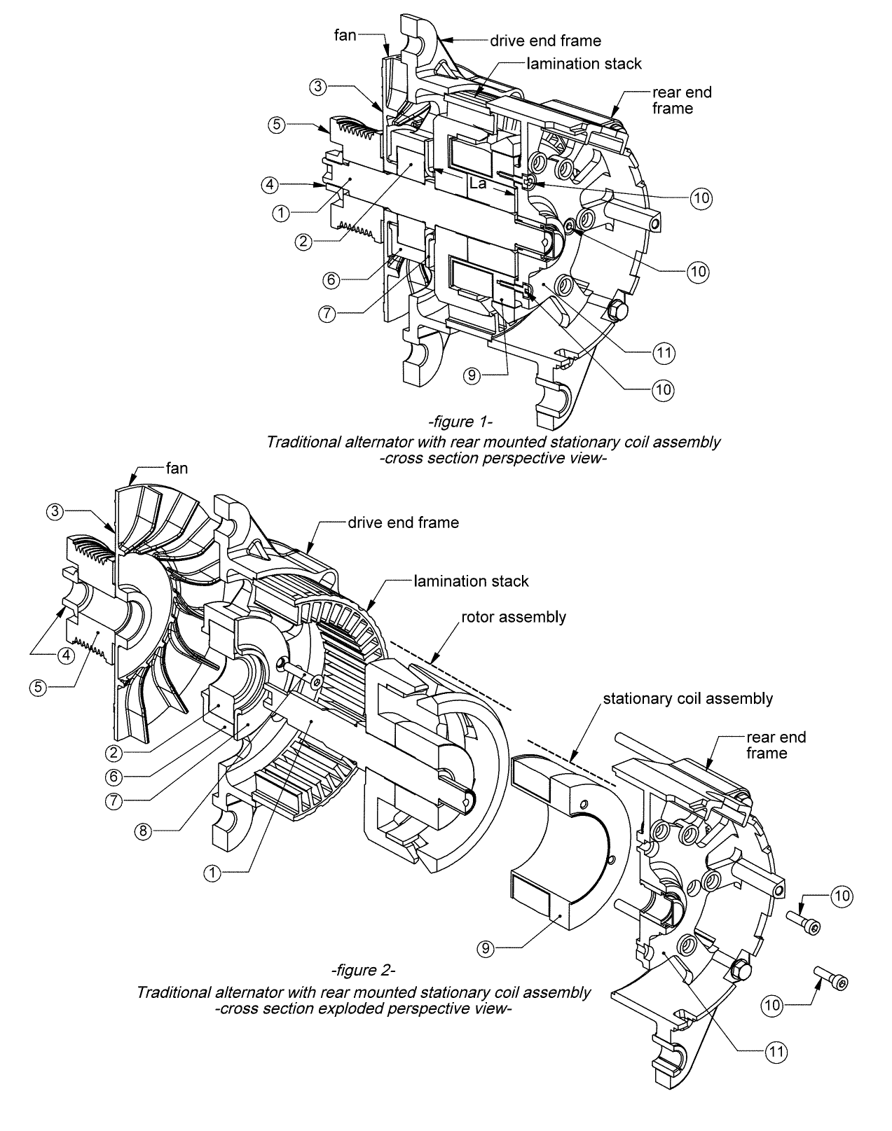

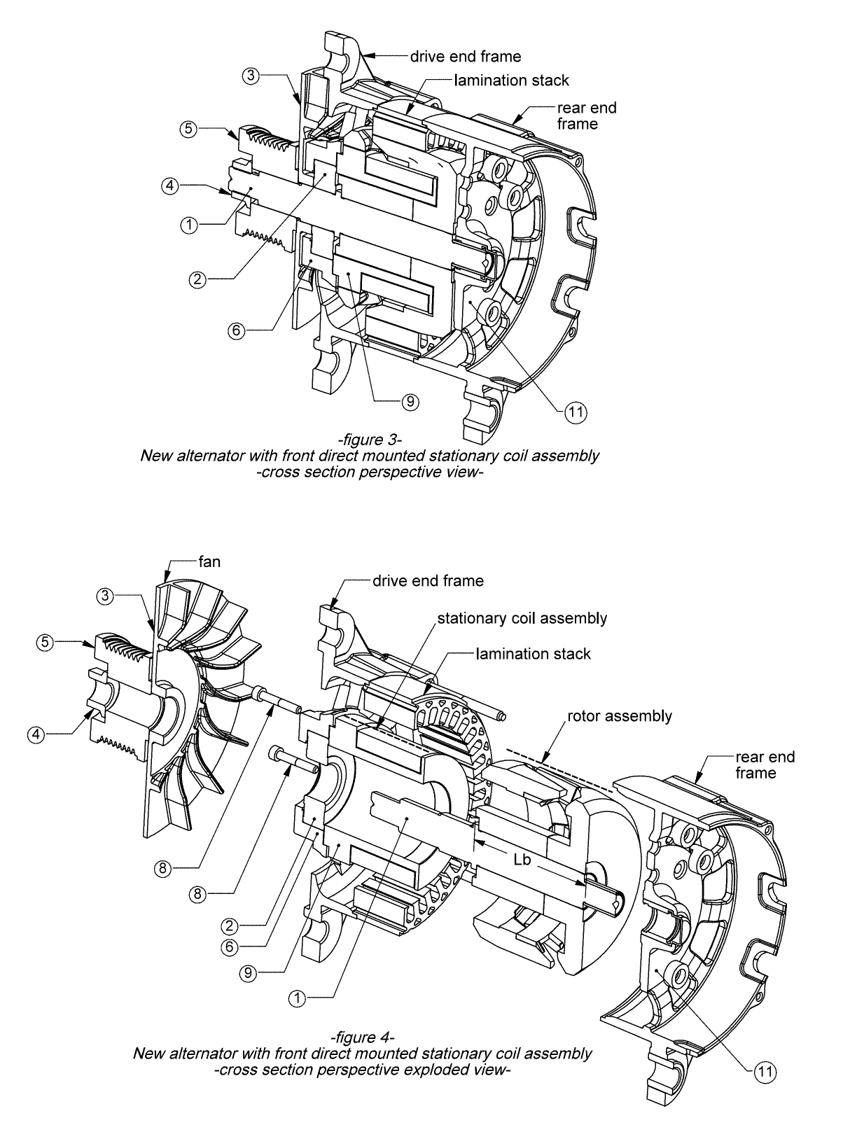

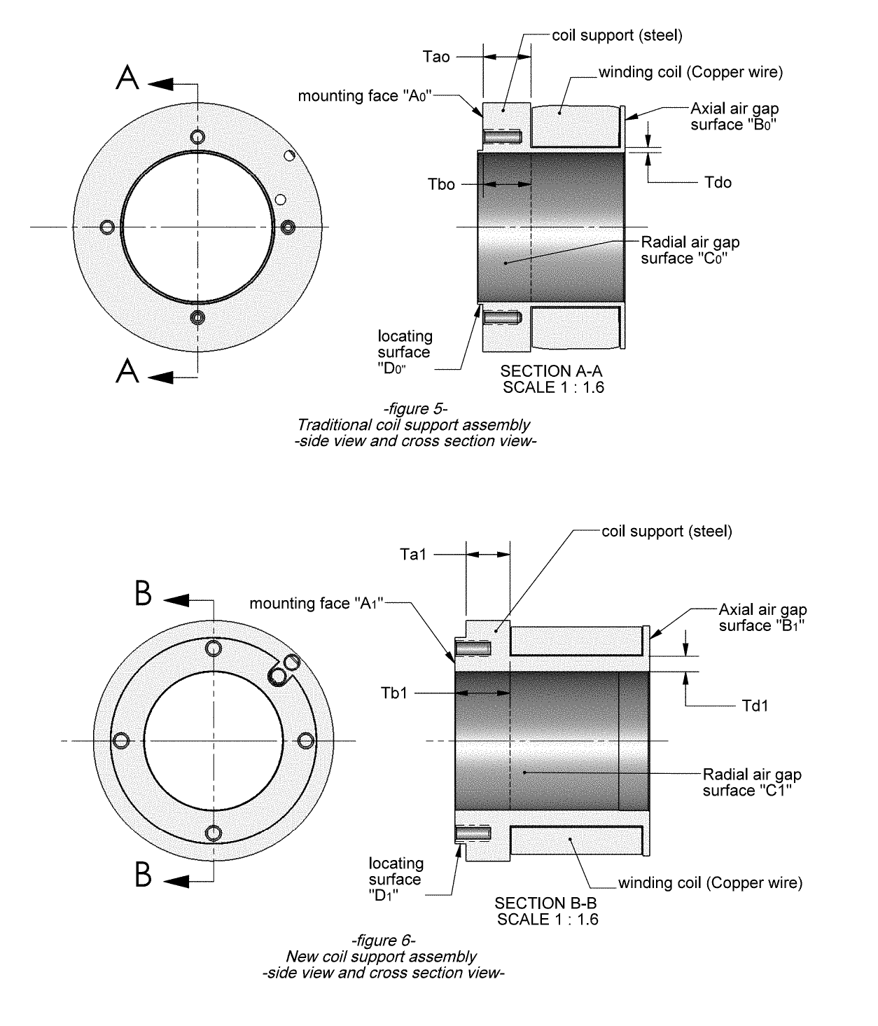

Referring to FIGS. 1, 2, and 5, in an alternator with a conventional stationary coil the drive end ball bearing (2) is radially located into the drive end frame (6). Axially, the drive end bearing (2) is supported to the left by the drive end frame (6) and to the right by the bearing cap (7) through the drive end screws (8). The drive end screws (8) clamp the outer race of drive end bearing (2) between the drive end frame (6) and the bearing cap (7). In this traditional design the bobbin of the stationary coil (9) does not rest against bearing (2). The stationary coil assembly (9) is mounted to the rear end frame (11) using screws (10). The bobbin of the stationary coil (9) rests against rear frame (11) interfacing with the rear frame (11) at mounting face “A0” and locating surface “D0” as shown on FIG. 5.

Referring to FIGS. 3, 4 and 6, this invention provides an alternator with a longer stationary coil support (bobbin) and rotor axial thereby increasing the output or efficiency of the alternator. The invention further provides a simplified design and more robust design. In particular, the drive end ball bearing (2) is radially located into the drive end frame (6) and is supported by the drive end frame (6) and the stationary bobbin (9). The drive end screws (8) clamp the drive end bearing (2) between the drive end frame (6) and the stationary bobbin (9). The bearing cap/retainer (7) found in conventional designs is therefore eliminated together with screws (10). As shown in FIGS. 3, 4 and 6 the bobbin (9) rests against the outer race of the bearing (2) through mounting surface “A1” and locating surface “D1”. The new design is simpler as screws (8) and bearing cap/retainer (7) are eliminated). The space created by deleting the cap (7) is now allocated to the bobbin and rotor axial length increasing the output or efficiency of the alternator.

By removing the bearing retainer and using a bobbin of the invention there is more room available to increase the rotor and bobbin assembly length. In some embodiments, the increase in length is approximately 6 mm.

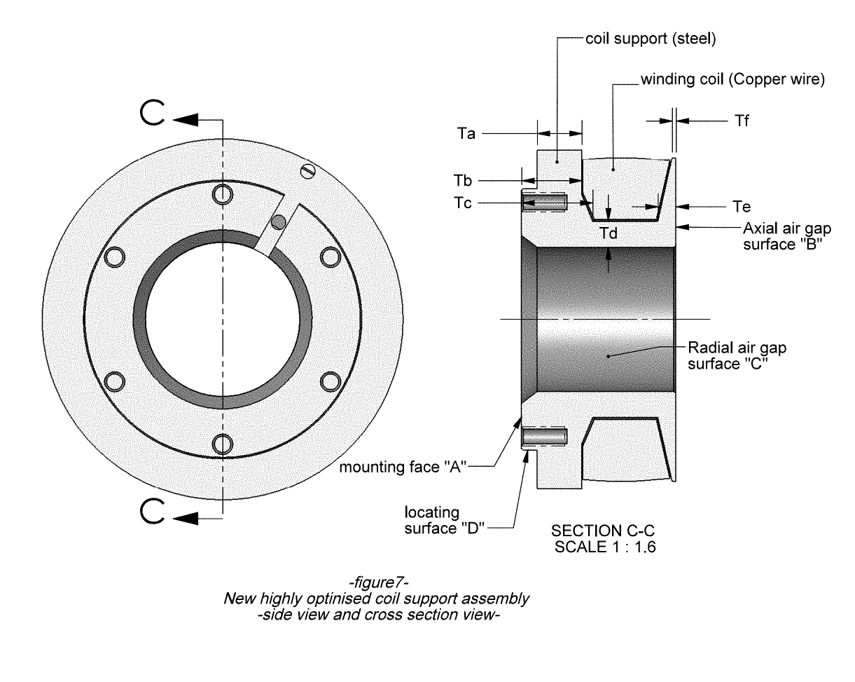

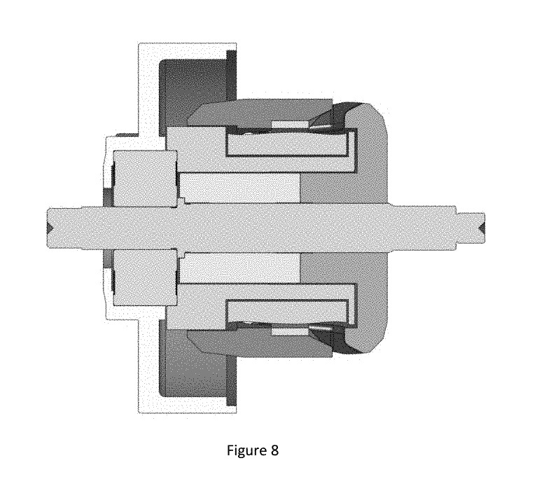

With reference to FIGS. 6 and 7, in operation, the new bobbin effectively charges the stator stack with increased levels of magnetism. The magnetic flux received by the bobbin from the rotor through surface Ta/Ta1 is transferred to inner surface Tb1/Tb and from here to radial surface C1/C. Second magnetic path appears when magnetic flux flows also sideways through bobbin bottom material Td1 and finally reaching axial gap surface B1 or B.

Without being limited by theory, it is believed that the magnetic flux carried by the new bobbin design as described in FIGS. 6 and 7 is superior to the traditional one as shown in FIG. 5 because of the increased thickness Tb1 or (Tb) and Td1 (Td), also increased magnetic flux going through surfaces B1 or B and surfaces C1 or C as opposed to reduced surface Tb0 and limited thickness Td0 and respectively reduced flux through surfaces C0 and B0.

To gain a better understanding of the invention described herein, the following examples are set forth. It will be understood that these examples are intended to describe illustrative embodiments of the invention and are not intended to limit the scope of the invention in any way.

### EXAMPLE

By using the design described herein, a 75 mm long rotor and bobbin assembly can be increased to 81 mm without physically increasing the size of the alternator. This represents by volume (rotor diameter stays the same) an 8% increase in the rotor & bobbin volume. The new rotor and bobbin assembly can be properly redesigned (“stretched”) to take advantage of the additional 6 mm. This will result in approximately 8% more power output delivered by the new alternator (all in the same package requirement.

Experimental Data:
28V test alternator output tests:

| | shorter rotor | 6 mm longer rotor |
|---|---|---|
| rotor speed | output | output |
| (rpm) | (Amps) | (Amps) |
| 1800 | 45 | 48 |
| 2000 | 54 | 59 |
| 3000 | 77 | 83 |
| 4000 | 88 | 94 |
| 5000 | 98 | 104 |
| 6000 | 105 | 110 |
| 6500 | 107 | 112 |

Various embodiments of the present invention having been thus described in detail by way of example, it will be apparent to those skilled in the art that variations and modifications may be made without departing from the invention.

The invention includes all such variations and modifications as fall within the scope of the appended claims.

We claim:

1. A claw type, brushless alternator comprising:
a drive end frame having a stationary coil assembly mounted thereto; the stationary coil assembly comprising a hollow bobbin and stationary coil wound thereon;
a stator circumscribing the stationary coil assembly such that a gap is provided between the stationary coil assembly and the stator;
a rotor assembly having a rotor shaft with pair of opposing claw type poles mounted thereon;
wherein each claw type pole has a plurality of fingers; wherein upon installation into the alternator, the rotor shaft is mounted through the hollow bobbin and the plurality of fingers are sandwiched between the stationary coil assembly and the stator.

2. The claw type, brushless alternator of claim 1; wherein the rotor shaft is steel.

3. The claw type, brushless alternator of claim 1; wherein the stationary coil is a copper wire coil.

4. The claw type, brushless alternator of claim 1, wherein the bobbin is a steel bobbin.

5. The claw type, brushless alternator of claim 1, wherein the hollow bobbin is mounted directly to the drive end frame.

6. A bobbin assembly for use in a claw type, brushless alternator, the brushless alternator having a drive end frame and drive end bearing, the bobbin assembly comprising:
a hollow bobbin with lips at each end of the hollow bobbin and defining a coil winding surface; and
a stationary coil wound on the hollow bobbin;
wherein one lip of the bobbin is configured for direct mounting to the drive end frame of the alternator and comprises a surface to support the drive end bearing.

7. The bobbin assembly of claim 6, wherein the drive end lip of the bobbin stepped.

8. The bobbin assembly of claim 7, wherein the step is configured engage a corresponding step of the drive end frame.

9. The bobbin assembly of claim 6, wherein each lip of the bobbin comprises an inclined surface resulting in the coil winding surface including sloped faces.

10. A claw type, brushless alternator comprising:
a drive end frame having a stationary coil assembly mounted thereto; the stationary coil assembly comprising the bobbin assembly of claim 6;
a stator circumscribing the stationary coil assembly such that a gap is provided between the stationary coil assembly and the stator;
a rotor assembly having a rotor shaft with pair of opposing claw type poles mounted thereon;
wherein each claw type pole has a plurality of fingers; wherein upon installation into the alternator, the rotor shaft is mounted through the hollow bobbin and the plurality of fingers are sandwiched between the stationary coil assembly and the stator.

11. A bobbin for use in a claw type, brushless alternator, the brushless alternator having a drive end frame and drive end bearing, the bobbin comprising:
a hollow cylinder with lips at each end of the hollow cylinder and defining a coil winding surface;
wherein one lip of the bobbin is configured for direct mounting to the drive end frame of the alternator and comprises a surface to support the drive end bearing.

12. The bobbin of claim 11, wherein the drive end lip of the bobbin stepped.

13. The bobbin of claim 12, wherein the step is configured engage a corresponding step of the drive end frame.

14. The bobbin of claim 11, wherein each lip of the bobbin comprises an inclined surface resulting in the coil winding surface including sloped faces.
